(19) United States
(12) Patent Application Publication
(10) Pub. No.: US 2005/0119097 A1
(43) Pub. Date: Jun. 2, 2005

(54) Paper feeding rubber roller and method of producing the same

(76) Inventor: Hirokazu Nishimori, Kobe-shi (JP)

Correspondence Address: BIRCH STEWART KOLASCH & BIRCH, PO BOX 747, FALLS CHURCH, VA, 22040-0747, US

(21) Appl. No.: 10/994,410

(22) Filed: Nov. 23, 2004

(30) Foreign Application Priority Data
Nov. 28, 2003 (JP) 2003-400298

(51) Int. Cl. B25F 5/02; F16C 13/00

(52) U.S. Cl. 492/56; 29/895.32

(57) ABSTRACT

An object of the present invention is to provide a paper feeding rubber roller capable of preventing paper powder from depositing and accumulating on the surface when a paper feeding and carrying treatment is repeated in a paper feeding and carrying system of an image forming apparatus, which can be produced by a simple manner, and a method of producing the same. The paper feeding rubber roller of the present invention is preferably produced in the following manner. That is, using a rubber containing a paraffin-, ester- or olefin-based plasticizer, a rubber roller made of a rubber having a hardness after vulcanization or crosslinking within a range from 30 to 37 in terms of JIS A hardness is molded, and then the surface of the rubber roller is polished by a cylindrical grinder to form polishing marks having an average height of 50 to 120 μm.

### TECHNICAL FIELD

The present invention relates to a paper feeding rubber roller used in a paper feeding and carrying system of copying machine, printer and facsimile, and a method of producing the same.

### BACKGROUND ART

Image forming apparatuses such as copying machine, printer and facsimile require a so-called paper feeding and carrying system which feeds and carries a transfer medium on which images are formed, such as paper. In such a paper feeding and carrying system, a rubber roller made of natural rubber, urethane rubber, ethylene-propylene-diene copolymer rubber (EPDM), silicone rubber, chlorinated polyethylene rubber, chloroprene rubber or norbornene rubber has hitherto been used.

However, a large amount of paper powder is deposited on the surface of the rubber roller by repeating the paper feeding and carrying treatment, thereby causing a problem in that a friction coefficient of the paper feeding rubber roller rapidly decreases.

Particularly, a rubber roller made of a material other than the norbornene rubber had such a problem that it becomes useless due to paper powder deposited on the surface before it becomes useless due to surface wear with a lapse of time. On the other hand, the paper feeding rubber roller made of the norbornene rubber can prevent the deposition of paper powder (so-called calcium carbonate-based paper powder) generated from a talc paper (paper containing a large amount of talc), but can not prevent the adsorption of paper powder containing a filler (for example, silica, titanium oxide, alumina or the like) in a color LBP paper or coated paper, thereby causing a problem that a wear coefficient of the rubber roller rapidly decreases due to adsorption of the paper powder containing a filler. Moreover, the norbornene rubber is not suited for use in a recent apparatus capable of forming images at high speed because of its poor wear resistance.

As a rubber roller capable of preventing paper feeding properties from deteriorating due to the deposition of paper powder, Japanese Published Unexamined Patent Application (Kokai Tokkyo Koho) No. Hei 5-221059 describes a paper feeding roller whose surface is processed by embossing of 20 to 30 μm average roughness.

However, in Japanese Published Unexamined Patent Application (Kokai Tokkyo Koho) No. Hei 8-108591, the present applicant pointed out that the paper feeding roller described in Japanese Published Unexamined Patent Application (Kokai Tokkyo Koho) No. Hei 5-221059 has a surface shape composed of smoothly continuous irregular waves and hardly catch a paper, and thus a friction coefficient becomes insufficient and paper carrying properties sometime deteriorate (paragraph number [0008]). The present applicant proposed a rubber roller having an embossed pattern comprising a land portion formed along the peripheral surface and a sea portion recessed from the land portion, wherein a occupancy ratio R (%) of the land portion calculated by a predetermined formula is set within a given range (claim 1), which should be replaced by such a paper feeding roller.

According to the rubber roller described in Japanese Published Unexamined Patent Application (Kokai Tokkyo Koho) No. Hei 8-108591, since the land and sea portions constituting the embossed pattern are arranged in suitably good balance on the peripheral surface of the rubber roller, it is made possible to maintain a sufficient friction coefficient for a long period and to secure excellent paper carrying properties (paragraph number [0013]).

However, this rubber roller is produced by vulcanizing and molding a rubber composition using a mold in which the mold surface corresponding to the peripheral surface of the rubber roller is subjected to processing corresponding to the embossed pattern (paragraph number [0021]) and a special mold subjected to processing such as embossing must be used, and thus the rubber roller is disadvantageous in view of cost and delivery date.

### DISCLOSURE OF THE INVENTION

An object of the present invention is to provide a paper feeding rubber roller capable of preventing paper powder from depositing and accumulating on the surface when a paper feeding and carrying treatment is repeated in a paper feeding and carrying system of an image forming apparatus, which can be produced by a simple manner, and a method of producing the same.

To achieve the above object, the paper feeding rubber roller of the present invention is made of a rubber having a hardness after vulcanization or crosslinking within a range from 30 to 37 in terms of JIS A hardness, the paper feeding rubber roller comprising, on the surface, polishing marks having an average height of 50 to 120 μm.

Since the paper feeding rubber roller comprises, on the surface, polishing marks having an average height of 50 to 120 μm, a decrease in the carrying force due to the accumulation of paper powder on the surface of the rubber roller is less likely to occur. The rubber hardness of the rubber roller is within a range from 30 to 37 in terms of JIS A hardness and is set within a preferable range so as to reconcile carrying properties of the paper and durability of the rubber roller itself.

The term “polishing marks” as used herein refers to unevenness of the surface of the rubber roller formed by a polishing treatment. The “height of polishing marks” is determined by measuring the surface condition of the paper feeding rubber roller using a three-dimensional surface roughness meter and calculating based on an outline of the surface condition made based on the measurement results.

Since a polishing treatment using a cylindrical grinder and the like is employed so as to form polishing marks on the surface of the paper feeding rubber roller, the operation and effect of preventing the deposition and accumulation of paper powder can be exerted by a simple manner.

Therefore, according to the paper feeding rubber roller of the present invention, it is made possible to maintain sufficient friction coefficient for a long period and to secure excellent paper carrying properties. Such a rubber roller is suited for use as a paper feeding rubber roller in a paper feeding and carrying system of an image forming apparatus.

The rubber constituting the paper feeding rubber roller of the present invention preferably contains a paraffin-, ester- or olefin-based plasticizer.

The paraffin-, ester- or olefin-based plasticizer is a plasticizer having low polarity and therefore has high affinity with the rubber constituting the rubber roller, and thus it is made possible to prevent such a problem that the plasticizer bleeds onto the surface of the rubber roller with a lapse of time (so-called bleeding). As a result, it is made possible to sufficiently suppress such a problem that paper powder and additives of the paper are adsorbed with a lapse of time by the plasticizer bled onto the surface of the rubber roller and a friction coefficient of the surface of the rubber roller decreases, thereby causing a decrease in a carrying force of the rubber roller.

In the paper feeding rubber roller of the present invention, the content of the plasticizer is preferably 100 parts by weight or less based on 100 parts by weight of the rubber. When the content of the plasticizer is set within the above range, it is possible to prevent a phenomenon wherein the roller is likely to be worn with the decrease in hardness of the roller such that polishing marks disappear early.

The rubber constituting the paper feeding rubber roller of the present invention is preferably molded by peroxide crosslinking.

The use of a peroxide (crosslinking agent) in place of a sulfur-based vulcanizing agent in case of molding a rubber roller does not cause such a problem that a sulfur-based vulcanizing agent bleeds onto the surface of the rubber roller after molding with a lapse of time (so-called blooming). Therefore, a problem such as a decrease in the friction coefficient of the surface of the rubber roller due to blooming does not arise.

The rubber constituting the paper feeding rubber roller preferably contains carbon black in the amount of 15 parts by weight or less based on 100 parts by weight of the rubber.

When a large amount of carbon black exists on the surface of the rubber roller after molding, there arises such a problem that the paper to be carried is contaminated. When the amount of carbon black is set within the above range, it is made possible to sufficiently suppress such a problem from occurring. When the amount of carbon black is appropriately set within the above range, it is made possible to prevent such a phenomenon that the rubber hardness of the rubber roller becomes excessively high.

The method of producing a paper feeding rubber roller of the present invention comprises molding a rubber roller made of a rubber having a hardness after vulcanization or crosslinking within a range from 30 to 37 in terms of JIS A hardness, and polishing the rubber roller to form polishing marks having an average height of 50 to 120 μm on the surface.

According to the above method, it is made possible to produce a paper feeding rubber roller capable of preventing paper powder from depositing and accumulating on the surface when a paper feeding and carrying treatment is repeated in a simple manner.

### BEST MODE FOR CARRYING OUT THE INVENTION

The paper feed rubber roller and the method of producing the same according to the present invention will now be described in detail.

(Rubber Material)

Examples of the rubber constituting the paper feeding rubber roller of the present invention include natural rubber, urethane rubber, ethylene-propylene-diene copolymer rubber (EPDM), silicone rubber, chlorinated polyethylene rubber, chloroprene rubber (CR), norbornene rubber, styrene-butadiene rubber (SBR), butadiene rubber (BR) and isobutylene-isoprene rubber (butyl rubber, IIR).

The material constituting the rubber roller is not specifically limited and is preferably a rubber which can be molded by crosslinking with a peroxide. Examples of such a rubber may include EPDM, silicone rubber, CR, SBR and BR. As the material constituting the rubber roller, for example, natural rubber, EPDM, BR, SBR and CR are preferably used in view of cost of the rubber roller. In view of the achievement of more excellent carrying properties making great account of the friction coefficient of the surface of the rubber roller, EPDM and CR are preferably used.

(Plasticizer)

Examples of the plasticizer to be blended with the rubber constituting the paper feeding rubber roller of the present invention include conventionally known various plasticizers. However, it is particularly preferred to use a paraffin-, ester- or olefin-based plasticizer among conventionally known plasticizers in view of the prevention of bleeding of the plasticizer, as described above.

Examples of the paraffin-based plasticizer include paraffin oils manufactured by Idemitsu Kosan Co., Ltd. under the trade name of “PW-90”, “PW-380” and “PS-90”.

Examples of the ester-based plasticizer include ester oils manufactured by Matsumura Oil Co., Ltd. under the trade name of “M18”, “M32” and “S50”.

Examples of the olefin-based plasticizer include olefin oils manufactured by Matsumura Oil Co., Ltd. under the trade name of “P18”, “P380” and “P46”.

As described above, the amount of the plasticizer is preferably 100 parts by weight or less based on 100 parts by weight of the rubber constituting the paper feeding rubber roller. The operation and effect exerted by setting the amount of the plasticizer within the above range is as described above.

The upper limit of the amount of the plasticizer is particularly preferably 80 parts by weight within the above range. On the other hand, the lower limit is preferably 50 parts by weight within the above range, and more preferably 70 parts by weight.

When the amount of the plasticizer is less than 50 parts by weight, it becomes impossible to sufficiently decrease the rubber hardness, which may cause a decrease in a friction coefficient (particularly initial value thereof) of the paper feeding rubber roller.

(Crosslinking Agent, Vulcanizing Agent)

Examples of the crosslinking agent and the vulcanizing agent to be blended with the rubber constituting the paper feeding rubber roller of the present invention include conventionally known various crosslinking agent and vulcanizing agent. However, it is preferred to use the crosslinking agent, not the vulcanizing agent, in view of the prevention of blooming onto the surface of the rubber roller, as described above.

Specific examples of the crosslinking agent include peroxides (organic peroxides) such as benzoyl peroxide and dicumyl peroxide (DCP); and resin crosslinking agents.

Examples of the sulfur-based vulcanizing agent include conventionally known vulcanizing agents, for example, sulfur, organic sulfur-containing compounds, vulcanization accelerators and co-agents of vulcanization accelerators.

Examples of the vulcanization accelerator include inorganic accelerators such as slaked lime, magnesia (MgO) and litharge (PbO); and organic accelerators, for example, thiurams such as tetramethylthiuram disulfide and tetraethylthiuram disulfide; dithiocarbamtes such as zinc dibutyldithiocarbamate and zinc diethyldithiocarbamate; thiazoles such as 2-mercaptobenzothiazole and N-cyclohexyl-2-benzothiazolesulfenamide; and thioureas such as trimethylthiourea and N,N′-diethylthiourea.

Examples of the co-agent of the vulcanization accelerator include sulfur compounds, oximenitroso compounds, monomers, zinc white and metal oxides.

The amount of the crosslinking agent and the vulcanization chemical is set according to the type of the crosslinking agent, etc. to be used and is not specifically limited, and is set within a range from 0.3 to 4 parts by weight, and preferably from 0.5 to 3 parts by weight, based on 100 parts by weight of the rubber.

(Other Components)

To the rubber constituting the paper feeding rubber roller of the present invention, conventionally known various components can be added. Examples of the other component include antioxidants, reinforcers and fillers.

Examples of the antioxidant include imidazoles such as 2-mercaptobenzimidazole; amines such as phenyl-α-naphthylamine, N,N′-di-β-naphthyl-p-phenylenediamine and N-phenyl-N′-isopropyl-p-phenylenediamine; and phenyls such as di-tert-butyl-p-cresol and styrenated phenyl.

Typical examples of the reinforcer include carbon black. As the other reinforcers, for example, there can be exemplified inorganic reinforcers such as silica- or silicate-based white carbon, zinc white, surface-treated precipitating calcium carbonate, magnesium carbonate, talc and clay; and organic reinforcers such as cumarone-indene resin, phenyl resin and hi-styrene (styrene-butadiene copolymer having high styrene content).

Examples of the filler include calcium carbonate, clay, barium sulfate and diatomaceous earth.

The amount of the other components is set according to the type of the components and physical properties required to the paper feeding rubber roller and may be appropriately set as long as characteristics of the present invention are not impaired and neither bleeding nor blooming are caused.

(Rubber Hardness of Rubber Roller)

As described above, the rubber hardness of the paper feeding rubber roller of the present invention is set within a range from 30 to 37 in terms of JIS A hardness.

When the rubber hardness of the rubber roller is higher than the above range, there arise a problem such as decrease in a friction coefficient (particularly initial value thereof) of the paper feeding rubber roller. On the other hand, when the rubber hardness is lower than the above range, there arises such a problem that durability of the rubber roller drastically deteriorates.

The lower limit of the rubber hardness of the paper feeding rubber roller of the present invention is particularly preferably 32 within the above range. On the other hand, the upper limit is particularly preferably 35 within the above range.

(Polishing Treatment)

As described above, a polishing treatment using a cylindrical grinder and the like is employed so as to form polishing marks on the surface of the paper feeding rubber roller of the present invention. In the cylindrical grinder, the moving rate of grindstone with respect to the rubber roller, the rotating speed of grindstone and the cutting depth of grindstone can be steplessly adjusted.

Since such a polishing treatment is employed in the production of a rubber roller in the present invention, the operation and effect of preventing the deposition and accumulation of paper powder can be exerted in a simple manner.

(Polishing Marks)

The term “polishing marks” as used herein refers to unevenness of the surface of the rubber roller formed by a polishing treatment.

The “height of polishing marks” is determined by measuring the surface condition of the paper feeding rubber roller using a three-dimensional surface roughness meter and calculating based on an outline of the surface condition made based on the measurement results.

The “height of polishing marks” as used herein is represented by an average height. The height is determined by measuring the condition of a curved surface (outer peripheral surface when fitting into a cylindrical measuring instrument) in the region of about 6.25 mm2 per one position among at least ten positions of the surface of the rubber roller and averaging these measurement results.

The average height of the surface of the paper feeding rubber roller of the present invention is set within a range from 50 to 120 μm.

When the average height of polishing marks is higher than the above range, there arises such a problem that a friction coefficient (particularly initial value thereof) of the paper feeding rubber roller decreases. On the other hand, when the average height of polishing marks is lower than the above range, there arises such a problem that polishing marks are easily clogged with paper powder deposited on the rubber roller and that polishing marks are worn before the number of papers passed therethrough reaches durable number of papers of the rubber roller according to the type of the paper to be carried by the rubber roller.

The lower limit of the average height of polishing marks on the surface of the paper feeding rubber roller of the present invention is preferably 60 μm within the above range, and more preferably 70 μm. On the other hand, the upper limit is preferably 100 μm within the above range, and more preferably 90 μm.

### EXAMPLES

The present invention will now be described by way of Examples and Comparative Examples.

(Material Constituting Rubber Roller)

As the material constituting the rubber roller, an ethylene-propylene-diene copolymer rubber (EPDM) manufactured by Sumitomo Chemical Industries Co., Ltd. under the trade name of “Esprene 671F” and/or a norbornene rubber manufactured by ZEON Corporation under the trade name of “Norsorex” were used.

As the filler, calcium carbonate (product No. “BF300”) manufactured by BIHOKU FUNKA KOGYO CO., LTD., fine titanium oxide particles manufactured by TITAN KOGYO KABUSHIKI KAISHA under the trade name of “KRONOS Titanium Oxide KR-380”, fine silica powders manufactured by TOSOH SILICA CORP. under the trade name of “Nipsil VN3” or carbon black manufactured by TOKAI CARBON CO., LTD. under the trade name of “SEAST 3 HAF” was used.

As the plasticizer, a paraffin-based plasticizer (paraffin oil manufactured by Idemitsu Kosan Co., Ltd. under the trade name of “PW-90” or paraffin oil manufactured by the same company under the trade name of “PW-380”), an ester-based plasticizer (ester-based oil manufactured by Matsumura Oil Co., Ltd. under the trade name of “M18”) or an olefin-based plasticizer (olefin-based oil manufactured by Matsumura Oil Co., Ltd. under the trade name of “P18”) was used.

As the crosslinking agent, dicumyl peroxide (DCP) manufactured by NOF Corp. under the trade name of Percumyl D was used.

(Production of Paper Feeding Rubber Roller)

### Example 1

100 Parts by weight of EPDM, 50 parts by weight of the paraffin-based plasticizer, 15 parts by weight of a filler (mixture of 10 parts by weight of calcium carbonate, 3 parts by weight of fine silica particles and 2 parts by weight of carbon black) and 2 parts by weight of dicumyl peroxide (DCP) as the crosslinking agent were mixed and kneaded. Although EPDM is oil-extended, the amount is indicated by the weight of only a rubber component (the same shall apply hereinafter).

The rubber composition thus obtained was press-vulcanized at 170° C. for 20 minutes to obtain a rubber roller having an inner diameter of 23 mm, an outer diameter of 32 mm and a length of 70 mm. Rubber hardness of the resulting rubber roller was 37 in terms of JIS A hardness.

After fitting a metal core into the rubber roller, the rubber roller was mounted in a cylindrical grinder manufactured by SHIGIYA MACHINERY WORKS LTD. and the surface was polished to form polishing marks having an average height of 63 μm. The rubber roller subjected to a polishing treatment had an outer diameter of 30 mm.

Furthermore, the rubber roller was cut to obtain a paper feeding rubber roller having a length of 26 mm.

### Example 2

100 Parts by weight of EPDM, 60 parts by weight of the paraffin-based plasticizer, 20 parts by weight of a filler (mixture of 10 parts by weight of calcium carbonate, 3 parts by weight of fine silica particles and 7 parts by weight of carbon black) and 2 parts by weight of dicumyl peroxide (DCP) were mixed and kneaded. Under the same conditions as in Example 1, except that the rubber composition thus obtained was used, the press vulcanization of the rubber composition, and the polishing treatment and cutting of the rubber roller were conducted to obtain a paper feeding rubber roller.

The rubber hardness of the rubber roller and the average height of polishing marks are as shown in Table 1.

### Example 3

100 Parts by weight of EPDM, 70 parts by weight of the paraffin-based plasticizer, 5 parts by weight of a filler (mixture of 3 parts by weight of calcium carbonate and 2 parts by weight of carbon black) and 2 parts by weight of dicumyl peroxide (DCP) were mixed and kneaded. Under the same conditions as in Example 1, except that the rubber composition thus obtained was used, the press vulcanization of the rubber composition, and the polishing treatment and cutting of the rubber roller were conducted to obtain a paper feeding rubber roller.

The rubber hardness of the rubber roller and the average height of polishing marks are as shown in Table 1.

### Example 4

100 Parts by weight of EPDM, 80 parts by weight of the paraffin-based plasticizer, 5 parts by weight of a filler (mixture of 3 parts by weight of calcium carbonate 2 parts by weight of carbon black) and 1 part by weight of dicumyl peroxide (DCP) were mixed and kneaded. Under the same conditions as in Example 1, except that the rubber composition thus obtained was used, the press vulcanization of the rubber composition, and the polishing treatment and cutting of the rubber roller were conducted to obtain a paper feeding rubber roller.

The rubber hardness of the rubber roller and the average height of polishing marks are as shown in Table 1.

### Example 5

100 Parts by weight of EPDM, 100 parts by weight of the paraffin-based plasticizer, 15 parts by weight of a filler (mixture of 10 parts by weight of calcium carbonate, 3 parts by weight of fine silica particles and 2 parts by weight of carbon black) and 2 parts by weight of dicumyl peroxide (DCP) were mixed and kneaded. Under the same conditions as in Example 1, except that the rubber composition thus obtained was used, the press vulcanization of the rubber composition, and the polishing treatment and cutting of the rubber roller were conducted to obtain a paper feeding rubber roller.

The rubber hardness of the rubber roller and the average height of polishing marks are as shown in Table 1.

### Comparative Example 1

100 Parts by weight of EPDM, 100 parts by weight of the paraffin-based plasticizer, 40 parts by weight of a filler (mixture of 20 parts by weight of calcium carbonate, 10 parts by weight of fine titanium oxide particles, 5 parts by weight of fine silica particles and 5 parts by weight of carbon black) and 4 parts by weight of dicumyl peroxide (DCP) were mixed and kneaded. Under the same conditions as in Example 1, except that the rubber composition thus obtained was used, the press vulcanization of the rubber composition, and the polishing treatment and cutting of the rubber roller were conducted to obtain a paper feeding rubber roller.

The rubber hardness of the rubber roller and the average height of polishing marks are as shown in Table 1.

### Comparative Example 2

100 Parts by weight of EPDM, 130 parts by weight of the paraffin-based plasticizer, 10 parts by weight of a filler (mixture of 5 parts by weight of calcium carbonate, 3 parts by weight of fine silica particles and 2 parts by weight of carbon black) and 3 parts by weight of dicumyl peroxide (DCP) were mixed and kneaded. Under the same conditions as in Example 1, except that the rubber composition thus obtained was used, the press vulcanization of the rubber composition, and the polishing treatment and cutting of the rubber roller were conducted to obtain a paper feeding rubber roller.

The rubber hardness of the rubber roller and the average height of polishing marks are as shown in Table 1.

### Comparative Example 3

10 Parts by weight of EPDM, 100 parts by weight of polynorbornene, 200 parts by weight of alkylbenzene (trade name: “A4, AB26”, 30 parts by weight of a filler (mixture of 10 parts by weight of calcium carbonate, 15 parts by weight of fine titanium oxide particles, 4 parts by weight of fine silica particles and 1 part by weight of carbon black) and 5 parts by weight of a vulcanizing agent (mixture of sulfur, tetraethylthiuram disulfide (TET), tellurium diethyldithiocarbamate (TTTE) and N-cyclohexyl-2-benzothiazolylsulfenamide (CZ)) were mixed and kneaded. Under the same conditions as in Example 1, except that the rubber composition thus obtained was used, the press vulcanization of the rubber composition, and the polishing treatment and cutting of the rubber roller were conducted to obtain a paper feeding rubber roller.

The rubber hardness of the rubber roller and the average height of polishing marks are as shown in Table 1.

(Evaluation of Physical Properties and Performances of Rubber Roller)

Measurement of Friction Coefficient

After inserting a talc paper (paper containing a large amount of talc, 60 mm×210 mm in size) between each of the rubber rollers obtained in the above Examples and Comparative Examples and a metal plate, a vertical load W of 2450 mN was applied to the talc paper. In such a state, the paper feeding rubber roller was rotated at a circumferential speed of 1200 mm/second and a carrying force F (mN) generated measured by a load cell. Furthermore, a friction coefficient μ was determined from the measured value of the carrying force F (mN) using the following equation.
μ=F/W

The friction coefficient μ was measured immediately after the production of the paper feeding rubber roller and the resulting value was taken as an initial value. The friction coefficient was also measured after conducting a paper passing test of the talc paper (120,000 papers were passed therethrough) which will be described hereinafter, and the resulting value was taken as a value after the paper passing test.

The initial value of the friction coefficient μ is preferably 1.5 or more. After the paper passing test of the talc paper (120,000 papers were passed therethrough), the value of the friction coefficient is preferably 1.1 or more, and more preferably 1.2 or more.

Measurement of Wear Amount

The initial weight of the paper feeding rubber roller before subjecting to the paper passing test and the weight thereof after passing 120,000 papers therethrough were respectively measured, and then a wear amount (volume-conversion value) was determined from a weight loss due to the paper-passing treatment and a specific gravity of each component.

Paper Passing Test

Each of the paper feeding rubber rollers obtained in the above Examples and Comparative Examples was mounted on a laser beam printer (maximum number of papers to be loaded: 250) manufactured by Canon Inc. under the trade name of “LBP470” and a paper passing test was conducted, and then paper feeding properties of the rubber roller was evaluated.

The paper passing test was conducted using a talc paper and a color LBP paper (“CLC paper of A4 size” manufactured by Canon Inc.). The former is an example in which a large amount paper powder is generated, while the latter is an example in which a phenomenon of depositing additives contained in the paper on the rubber roller occurs severely.

120,000 Papers were passed through the printer in the case of the talc paper, while 10,000 papers were passed through the printer in the case of the color LBP paper.

As a result of the paper passing test, the number of feeding of the talc paper or CLC paper using the paper feeding rubber roller was compared with the number of actually ejected papers, and then paper feeding properties were evaluated by the degree of a difference (occurrence of miss-feeding) according to the following criteria.
AAA: Neither miss-feeding nor jamming occurred and paper feeding properties were excellent.
AA: Miss-feeding did not occur and jamming slightly occurred when the number of papers passed therethrough comes near the durable number of papers of the rubber roller, while paper feeding properties were good.
A: Jamming occurred, while miss-feeding did not occur finally. Paper feeding properties were excellent and sufficient for practice.
B: Miss-feeding and a phenomenon of simultaneously feeding plural papers (double feeding) occurred frequently.

The above results are shown in Table 1.

TABLE 1

| | | | | | | Comparative | | |
|---|---|---|---|---|---|---|---|---|
| | Examples | | | | | Examples | | |
| | 1 | 2 | 3 | 4 | 5 | 1 | 2 | 3 |
| [Composition of roller] | | | | | | | | |
| EPDM | 100 | 100 | 100 | 100 | 100 | 100 | 100 | 10 |
| Polynorbornene | — | — | — | — | — | — | — | 100 |
| Plasticizer | 50 | 60 | 70 | 80 | 100 | 100 | 130 | 200 |
| Filler | 15 | 20 | 5 | 5 | 15 | 40 | 10 | 30 |
| Crosslinking agent | 2 | 2 | 2 | 1 | 2 | 4 | 3 | 5 |
| [Evaluation of physical properties and | | | | | | | | |
| performances of roller] | | | | | | | | |
| Average height of polishing marks (μm) | 63 | 73 | 78 | 58 | 51 | 45 | 41 | 43 |
| Surface hardness (JIS A) | 37 | 35 | 33 | 32 | 30 | 25 | 24 | 18 |
| Initial value of friction coefficient μ | 1.48 | 1.55 | 1.65 | 1.75 | 1.8 | 1.8 | 1.9 | 1.8 |
| Friction coefficient after paper passing | 1.1 | 1.1 | 1.3 | 1.3 | 1.1 | 0.8 | 0.9 | 1.2 |
| test μ | | | | | | | | |
| Ratio of wear amount | 25 | 30 | 39 | 51 | 72 | 72 | 92 | 100 |
| Paper feeding properties after passing | | | | | | | | |
| through papers | | | | | | | | |
| Talc paper | A | A | AAA | AA | A | B | B | A |
| Color LBP paper | A | A | AA | AA | A | A | A | B |

As is apparent from the results shown in Table 1, the paper feeding rubber rollers of Examples 1 to 5 are excellent in durability and can maintain excellent paper feeding properties regardless of the type of paper.

On the other hand, in case of the paper feeding rubber rollers of Comparative Examples 1 and 2 wherein polishing marks on the surface have a low average height and the rubber hardness is low, the initial value of the friction coefficient was comparatively high because of low rubber hardness, while polishing marks were likely to be clogged with paper powder generated by passing the talc paper therethrough and the friction coefficient drastically decreased with a lapse of time. The paper feeding rubber rollers of Comparative Example 2 had problems such as large wear amount and poor durability.

In case of the paper feeding rubber roller of Comparative Example 3 wherein a rubber containing polynorbornene as a main component is used as a material constituting the rubber roller, while polishing marks have a low average height and also the low rubber hardness is low, a decrease in a friction coefficient due to paper powder could be prevented because of the use of polynorbornene, while a friction coefficient drastically decreased due to the deposition of a filler of the color LBP paper.

(Production of paper feeding rubber roller)

### Example 6

100 Parts by weight of EPDM, 70 parts by weight of the paraffin-based plasticizer, 15 parts by weight of a filler (mixture of 10 parts by weight of calcium carbonate, 3 parts by weight of fine silica particles and 2 parts by weight of carbon black) and 2 parts by weight of dicumyl peroxide (DCP) as the crosslinking agent were mixed and kneaded. Under the same conditions as in Example 1, except that the rubber composition thus obtained was used, the press vulcanization of the rubber composition, and the polishing treatment and cutting of the rubber roller were conducted to obtain a paper feeding rubber roller.

The rubber hardness of the rubber roller and the average height of polishing marks are as shown in Table 2.

### Example 7

100 Parts by weight of EPDM, 70 parts by weight of the paraffin-based plasticizer, 15 parts by weight of a filler (mixture of 10 parts by weight of calcium carbonate, 3 parts by weight of fine silica particles and 2 parts by weight of carbon black) and 2 parts by weight of dicumyl peroxide (DCP) as the crosslinking agent were mixed and kneaded. Under the same conditions as in Example 1, except that the rubber composition thus obtained was used, the press vulcanization of the rubber composition, and the polishing treatment and cutting of the rubber roller were conducted to obtain a paper feeding rubber roller.

The rubber hardness of the rubber roller and the average height of polishing marks are as shown in Table 2.

### Comparative Example 4

100 Parts by weight of EPDM, 70 parts by weight of the paraffin-based plasticizer, 15 parts by weight of a filler (mixture of 10 parts by weight of calcium carbonate, 3 parts by weight of fine silica particles and 2 parts by weight of carbon black) and 2 parts by weight of dicumyl peroxide (DCP) as the crosslinking agent were mixed and kneaded. Under the same conditions as in Example 1, except that the rubber composition thus obtained was used, the press vulcanization of the rubber composition, and the polishing treatment and cutting of the rubber roller were conducted to obtain a paper feeding rubber roller.

The rubber hardness of the rubber roller and the average height of polishing marks are as shown in Table 2.

### Example 8

100 Parts by weight of EPDM, 50 parts by weight of the paraffin-based plasticizer, 15 parts by weight of a filler (mixture of 10 parts by weight of calcium carbonate, 3 parts by weight of fine silica particles and 2 parts by weight of carbon black) and 3 parts by weight of dicumyl peroxide (DCP) as the crosslinking agent were mixed and kneaded. Under the same conditions as in Example 1, except that the rubber composition thus obtained was used, the press vulcanization of the rubber composition, and the polishing treatment and cutting of the rubber roller were conducted to obtain a paper feeding rubber roller.

The rubber hardness of the rubber roller and the average height of polishing marks are as shown in Table 2.

### Example 9

100 Parts by weight of EPDM, 100 parts by weight of the paraffin-based plasticizer, 15 parts by weight of a filler (mixture of 10 parts by weight of calcium carbonate, 3 parts by weight of fine silica particles and 2 parts by weight of carbon black) and 3 parts by weight of dicumyl peroxide (DCP) as the crosslinking agent were mixed and kneaded. Under the same conditions as in Example 1, except that the rubber composition thus obtained was used, the press vulcanization of the rubber composition, and the polishing treatment and cutting of the rubber roller were conducted to obtain a paper feeding rubber roller.

The rubber hardness of the rubber roller and the average height of polishing marks are as shown in Table 2.

### Comparative Example 5

100 Parts by weight of EPDM, 50 parts by weight of the paraffin-based plasticizer, 15 parts by weight of a filler (mixture of 10 parts by weight of calcium carbonate, 3 parts by weight of fine silica particles and 2 parts by weight of carbon black) and 2 parts by weight of dicumyl peroxide (DCP) as the crosslinking agent were mixed and kneaded. Under the same conditions as in Example 1, except that the rubber composition thus obtained was used, the press vulcanization of the rubber composition, and the polishing treatment and cutting of the rubber roller were conducted to obtain a paper feeding rubber roller.

The rubber hardness of the rubber roller and the average height of polishing marks are as shown in Table 2.

(Evaluation of Physical Properties and Performances of Rubber Roller)

With regard to rubber rollers of Examples 6 to 9 and Comparative Examples 4 to 5, “measurement of friction coefficient”, “measurement of wear amount” and “paper passing test” were conducted and various physical properties and performances were evaluated. The above results are shown in Table 2.

TABLE 2

| | Examples | | Comparative | Examples | | Comparative |
|---|---|---|---|---|---|---|
| | 6 | 7 | Example 4 | 8 | 9 | Example 5 |
| [Composition of roller] | | | | | | |
| EPDM | 100 | 100 | 100 | 100 | 100 | 100 |
| Polynorbornene | — | — | — | — | — | — |
| Plasticizer | 70 | 70 | 70 | 50 | 100 | 50 |
| Filler | 15 | 15 | 15 | 15 | 15 | 15 |
| Crosslinking agent | 2 | 2 | 2 | 3 | 3 | 2 |
| [Evaluation of physical properties and | | | | | | |
| performances of roller] | | | | | | |
| Average height of polishing marks (μm) | 100 | 120 | 135 | 100 | 120 | 135 |
| Surface hardness (JIS A) | 37 | 35 | 32 | 37 | 30 | 38 |
| Initial value of friction coefficient μ | 1.72 | 1.63 | 1.50 | 1.45 | 1.75 | 1.35 |
| Friction coefficient after paper passing | 1.3 | 1.3 | 1.25 | 1.1 | 1.2 | 1.0 |
| test μ | | | | | | |
| Ratio of wear amount | 40 | 43 | 43 | 27 | 79 | 30 |
| Paper feeding properties after passing | | | | | | |
| through papers | | | | | | |
| Talc paper | AAA | AAA | B | A | A | B |
| Color LBP paper | AA | AA | A | A | A | A |

As is apparent from the results shown in Table 2, the paper feeding rubber rollers of Examples 6 to 9 are excellent in durability and can maintain excellent paper feeding properties regardless of the type of paper.

On the other hand, in case of the paper feeding rubber rollers of Comparative Examples 4 and 5, the initial value of the friction coefficient decreased because the average height of polishing marks on the surface of the rubber roller is too high, while polishing marks were likely to be clogged with paper powder generated by passing the talc paper therethrough and the friction coefficient drastically decreased with a lapse of time.

While preferred embodiments of the invention have been described and illustrated above, it should be understood that these are exemplary of the invention and are not to be considered as limiting. All variations of the present invention, which readily suggest themselves to those skilled in the art, fall within the appended claims illustrated below.

The disclosure of Japanese patent application Serial No. 2003-400298, filed on Nov. 28, 2003, is incorporated herein by reference.

1. A paper feeding rubber roller made of a rubber having a hardness after vulcanization or crosslinking within a range from 30 to 37 in terms of JIS A hardness, the paper feeding rubber roller comprising, on the surface, polishing marks having an average height of 50 to 120 μm.

2. The paper feeding rubber roller according to claim 1, wherein the rubber constituting the rubber roller contains a paraffin-, ester- or olefin-based plasticizer.

3. The paper feeding rubber roller according to claim 2, wherein the content of the plasticizer is 100 parts by weight or less based on 100 parts by weight of the rubber constituting the rubber roller.

4. The paper feeding rubber roller according to claim 1, wherein the rubber constituting the rubber roller is molded by peroxide crosslinking.

5. The paper feeding rubber roller according to claim 1, wherein the rubber constituting the rubber roller contains 15 parts by weight or less of carbon black in 100 parts by weight of the rubber.

6. A method of producing a paper feeding rubber roller, which comprises molding a rubber roller made of a rubber having a hardness after vulcanization or crosslinking within a range from 30 to 37 in terms of JIS A hardness, and polishing the rubber roller to form polishing marks having an average height of 50 to 120 μm on the surface.
